(19) United States
(12) Patent Application Publication
(10) Pub. No.: US 2010/0104473 A1
(43) Pub. Date: Apr. 29, 2010

(54) Air sampling system and method for calibration

(76) Inventors: Kirollos Salama Kirollos, Virginia Beach, VA (US); Gueorgui Milev Mihaylov, Virginia Beach, VA (US)

Correspondence Address: Kirollos S. Kirollos, 1701 Butterchum Court, Virginia Beach, VA, 23456, US

(21) Appl. No.: 12/384,370

(22) Filed: Apr. 3, 2009

Related U.S. Application Data
(63) Continuation of application No. 10/702,807, filed on Nov. 6, 2003, now abandoned.

(51) Int. Cl. G01N 35/10; G01N 1/22; G01N 31/00; G01N 31/22

(52) U.S. Cl. 422/58; 422/83; 422/93; 422/86; 422/88

(57) ABSTRACT

A chemical detection system includes detectors connected to a pump via a filter and hosing. The filter prevents the interior of the pump from internal contamination from a chemical or toxic agent. The airflow through the detector may be varied by an adjustable orifice. A pistol grip for holding the system and operating it is balanced with respect to a center of gravity.

The present application relates to and claims priority from U.S. patent application Ser. No. 10/702,807 filed on Nov. 6, 2003.

### FIELD OF INVENTION

This invention relates to an active type of air sampling device for simultaneously sampling several air contaminants. More particularly, the invention relates to a colorimetric type air sampling device that simultaneously analyzes an air sample and alerts an operator when one or more types of contaminants are present in the sampled air.

### BACKGROUND OF INVENTION

There is an increased demand for devices that quickly and simultaneously detect and quantify highly toxic substances in air, particularly chemical warfare agents. The detection and quantification of chemical warfare agents require a wide variety of highly sensitive and fast responding reagents. Further, simultaneous determination of chemical warfare agents is a complex analytical task. Detector tubes for several classes of chemical warfare agents have been developed, but the synchronized use of those tubes is very complicated. Each type tube requires a specific sampling air volume as well as a specific rate of airflow. Moreover, most known detector tubes require different analytical procedures resulting in several necessary steps for processing the air sample. These steps differ between the different types of detector tubes. The length of time necessary for using each type of tube renders the individual use of tubes unsatisfactory for military, Civil Defense, and first responder's personnel during emergency situations. Thus, there is a great demand for a method and/or a device that simultaneously samples and analyzes air to detect chemical warfare agents in a relatively short period of time.

### SUMMARY OF THE INVENTION

In view of the foregoing problems of using multiple detector tubes, it is apparent that there is a need for a portable air sampling system that simultaneously collects air samples in a simple and precise manner in order to accurately and quickly identify the possible presence of a wide variety of toxic substances such as chemical warfare agents in the air of an occupied urban area or on the battlefield.

More particularly, it is an object of the present invention to provide an air sampling system as previously mentioned having simple and reliable components which operate in an unobstructive manner.

It is another object of the present invention to provide an air sampling system which can be readily and accurately calibrated in accordance with the requirements for each single colorimetric or otherwise sampling device using a calibration system in an effective manner.

Another object of the present invention is to provide an air sampling system which utilizes easy to assemble components and which is easy for the user to operate in an emergency. The present system includes options of electric or Venturi pumps to reduce physical effort during sampling and hence minimize the possibility of an incorrect analysis.

Another object of the present invention is to provide quick connect/disconnect components keyed to fit in only one way to prevent incorrectly connecting the components in wrong manner, and thereby reducing the chance of an incorrect sampling and analysis result.

Yet another objective of this invention is to provide an air sampling system that only requires the use of one hand of the operator and is capable of sampling air in an exact sampling point within a normal breathing zone, high above the ground or in an opening of a manhole.

Another objective of the present invention is to prevent as much of the afore-mentioned sampling system as possible from internal contamination which could cause its disposal or could result in lengthy and expensive decontamination procedures.

Another objective of the present invention is to have the ability to store the air sampling system for a long period of time and to immediately use it in case of an emergency without the need for a fresh power supply.

Another objective of the present invention is to have reliable and fast means for sampling multiple substances by a non-technical person without the need for frequent training.

Yet another objective of the present invention is to have a one-button key for setup and operation when an electric pump is used.

A further objective is to provide a system that analyzes an air sample for simultaneous detection of multiple chemical agents.

An additional objective is to provide a system that utilizes several detector tubes, each comprising a different reagent, to simultaneously detect the presence or absence of multiple chemical agents in an air sample.

A further objective is to provide a system for using several detector tubes to simultaneously analyze an air sample, where each detector tube requires a specific sampling air volume and specific rate of airflow.

A further objective is to provide a system for use with multiple detector tubes. The system includes an adjustment and control means for controlling a volume of air and rate of airflow through the detector tubes.

Briefly described, the invention comprises a one-hand operated, ergonomic, gravity balanced upright self-standing system for simultaneous qualitative and quantitative air sampling of individual analytes or a plurality of analytes. The system comprises means for removably affixing an individual sampling device or a plurality of sampling devices removably affixed within a holder. A means of controlling a preset air flow through an individual sampling device or plurality of sampling devices is also included in the invention. The system further includes a means for holding the system in upright position. A means of controlling withdrawn air humidity is incorporated into the system. An in-line decontamination filtration means prevents the internal workings of the system from becoming contaminated. The system also includes a means for controlling temperature of sampled air and is equipped with a flotation device. Air is moved through an individual sampling device or a plurality of sampling devices, in series with adjustable and/or restricted orifices that are engaged with the upright holding means to conduct detection of individual analytes or plurality of analytes in air.

Connection points for the various elements used in sampling the air include a quick engaging couplers, such as between the means of controlling a preset air flow though an individual sampling device or plurality of sampling devices to a means of moving air through each individual sampling device or a plurality of sampling devices. The system further comprises means of controlling and recording a preset predefined air volume and/or air flow rate drawn through the system.

Another embodiment of the system includes a means for removably affixing an individual sampling device or plurality of sampling devices in a removably affixing holder that includes a removably affixing clear plastic pressure sensitive tape 24; a snap-in mechanism including sockets that hold at least one sampling device on the removably affixing holder; and, means of protecting an operator's hands from sharp edges of an opened individual sampling device.

A further embodiment of the invention includes a means of controlling a preset air flow through an individual sampling device that includes means of removably affixing an individual sampling device or plurality of sampling devices; means of controlling air flow and/or air volume with an adjustable limiting orifice; means of removably affixing the means of controlling air flow and/or air volume with an adjustable limiting orifice; means of opening an individual sampling device or a plurality of sampling devices; means of crushing glass ampoules; quick connection means for connecting to said means of moving air through the individual sampling device or a plurality of sampling devices; and, a protective bag or covering that encapsulates the system to prevent external contamination.

In a further embodiment, the system includes a means of holding the system on upright position that includes a means of engaging means of controlling a preset air flow through an individual sampling device or a plurality of sampling devices; a means of engaging the means of moving air through the individual sampling device or plurality of sampling device such as a threaded bayonet fitting; a pistol grip handle; and, a protective bag to prevent external contamination of the system.

In another embodiment, the system includes a quick engaging means between the means of controlling preset air flow through individual sampling devices to the means of moving air through individual sampling devices that includes a means for quickly snapping in a removably affixing mechanism to hold the means of moving air through the individual sampling devices; means of removably affixing with a threaded bayonet fitting to hold the means of holding the system on an upright position; and, an L-shaped member with threaded fittings on both ends or bayonet fittings on both ends or thread fittings and bayonet fittings on each end.

In a further embodiment, the system includes a means of moving air through individual sampling devices that includes a pump such as an electric pump, Venturi pump assembly or hand piston pump; and, means of quickly connecting and disconnecting the suction flow to the means of controlling a preset air flow through an individual sampling device or a plurality of sampling devices. This embodiment may also include an electric pump that comprises a constant airflow or variable airflow; at least one adjustable sampling parameter sensor for monitoring air flow, air volumes, back pressure, run time or the like; an exit port or pump discharge flow inside the pump housing that creates a positive internal pressure to prevent contaminants from entering the pump; a shielded exhaust to prevent water from entering the pump; a means of charging a power supply for the pump from alternating current, direct current, solar power or manual cranking energy supplies; means of identifying battery and estimating percentage of life service and how much run time is left; a digital imaging system to take pictures of sampling devices after sampling and compare result to stored data; a preset programmable button to control operations of the system; a readable digital display; a failure indicator for indicating failures relating to air flow rate, air volume and run time; a means of measuring and recording ambient temperature, humidity and pressure and automatically compensating or adjusting preset sampling parameters; means of communicating programmable sampling parameters from a remote location to the system; and, means of recording part number, lot numbers, expiration dates, and serial numbers of individual sampling devices and automatically notify user and manufacturer of such information.

Another embodiment of the invention includes a Venturi pump assembly comprising means of controlling and measuring air volume and air pressure; means for safely releasing pressurized air; means of quickly connecting and disconnecting the means of controlling preset air flow through an individual sampling device or plurality of sampling devices; and, a protective bag to prevent external contamination.

The system may further include a hand piston pump that comprises a 500 cc air volume capacity; a self actuated stroke counter; stops for indicating 100 cc, 200 cc, 300 cc, 400 cc air sampling volumes; and, an one-hand adapter for a vacuum leak.

An additional embodiment of the invention may include detecting an individual or a plurality of analytes that include but are not limited to warfare agents and indoor air pollutants.

Further embodiments of the invention include an individual sampling device comprising a direct read, length of stain quantitative and semi-quantitative colorimetric detector tube, a sorption tube, a filter housing, an impinger that is either unscored or prescored; a printed part number and lot number for visual and digital recognition by the operator; an inside diameter ranging between 2.0 mm and 4.8 mm; and, after use caps 22 used for sealing the used sampling device for proper disposal.

An additional embodiment includes a plurality of sampling devices that comprise two to five sampling devices. A further embodiment of the system may include a plurality of sampling devices that includes adjustable sampling parameters including air flow, air volume, back pressure, runs time and further comprises flow rates in the range of 0.5 L/min to 5.0 L/min for at least one sampling device, flow rates in the range of 0.75 L/min to 7.50 L/min for at least one sampling device, flow rates in the range of 1.0 L/min to 10.0 L/min for at least one sampling device, flow rates in the range of 1.2 L/min to 12.0 L/min for at least one sampling device; air volumes in the range of 1.5 L to 15 L for at least one sampling device, air volumes in the range of 2 to 25 L for at least one sampling device, air volumes in the range of 2.5 L to 40 L for at least one sampling device, air volumes in the range of 3 L to 30 L for at least one sampling devices; back pressures in the range of 60″ water to 20″ water for at least one sampling device, back pressures in the range of 55″ water to 15″ water for at least one sampling device, back pressures in the range of 50″ water to 10″ water for at least one sampling device, back pressures in the range of 48″ water to 7″ water for at least one sampling device; and, run times in the range of 1 minutes to 5 minutes for at least one sampling device, run times in the range of 1 minutes to 5 minutes for at least one sampling device, run times in the range of 2 minutes to 7 minutes for at least one sampling device, run times in the range of 2.5 minutes to 10 minutes for at least one sampling device.

A further embodiment of the system may include back pressure that is the same value for all sampling devices or alternatively a unique value for each individual sampling device.

An additional embodiment may include a means of controlling air flow and/or air volume with an adjustable limiting orifices further comprising individual uniquely shaped and sized orifices to avoid an incorrect placement of a sampling tube to create an improper position; flat bar-shaped different orifices; dial-in design of different orifices; or preset orifices for specific sets of sampling devices for different applications.

The system may include a means of in-line decontamination filtration further comprising an end of service life indicator; and after use caps for proper disposal.

In short, the above listed objectives of the present invention are accomplished by providing a sampler head having parallel branches that enable the use of multiple active sampling components in parallel and simultaneously allows the collection and identification of multiple contaminants while using a single pump. These components can be sorption sampling tubes, colorimetric detector or length-of-stain tubes, dust and aerosol filter arrays or filter housings.

As far as each of the parallel sampling devices require a particular airflow and a total sampling volume, the total airflow is drawn by the pump at a preset vacuum level and particular airflows for each sampling device is adjusted by an adjustable aerodynamic resistance. Thus, the total airflow of the air sampling system drawn by the pump is a sum of all individual adjusted airflows. As the sampling time for all components of the system is the same, all sampling devices should be calibrated in a dynamic regimen with their particular aerodynamic flow resistances to achieve the required total sampling volume for each device. The system is calibrated in such a manner that each device shares part of the total airflow drawn from the pump in a wide range of vacuum settings. This allows the use of different pumping devices that can provide a required sampling vacuum for predetermined time intervals, resulting in the same total air sampling volume. The system is flexibly designed to use an electric pump, a Venturi pump or a hand/foot driven pump provided that the total sampling volume and time are the same and the shared particular flows are within the predetermined (during the calibration) ratio.

The afore mentioned electric suction pump has a logging system which includes a microprocessor and software that provides programming and relevant sampling information relating to variables such as pumping flow rate, battery charge, time, temperature and atmospheric pressure.

The afore mentioned Venturi pump unit includes a pressure releasing valve (membrane) regulator and flow meter with a needle valve for fine tuning the total airflow. The aforementioned hand/foot pump is designed to provide a high volume of air per stroke at a comparably low vacuum.

In order to calibrate an air sampling system of the present invention, a method and devices have been developed. The method is comprised of the following steps:
Measuring each particular sampling device's aerodynamic resistance to air flow (and vacuum) corresponding to the total particular device sampling volume and estimating the statistical average;
Measuring the total air flow shared by each branch of the device;
Measuring the total sampled volume of sampled air;
Adjusting multiple specially designed simulated air resistances to the statistical average for each branch with the device;
Adjusting air flow for each particular branch of the device such that all branches are in parallel and each simulated resistance is in serial flow with its particular adjustable resistance; and,
Substituting simulated resistances with real sampling resistances.

All sampling devices, with the exception of one, are mounted on the surface of a holder an equal distance from one another. Only one branch, preferably the furthermost to the left or right side is mounted at an unequal distance from the branch nearest it such that the holder of the devices can be introduced to the receptacle socket in only one way. That is to say, the operator cannot improperly mount the sampling devices on the holder.

A universal gases and vapors filter is disposed between the sampling branches and the sampling system pump. The purpose of the filter is to stop and remove the toxic volatiles that might otherwise pass through the air sampling devices and contaminate the sampling system pump.

### BRIEF DESCRIPTION OF THE DRAWINGS

FIG. 1 is a perspective view of the generic assembly of the air sampling system comprising an air sampling holder and sampling head with branches for moving air through a plurality of sampling devices in series pneumatically connected to electric pump.

FIGS. 2A-2F are perspective views of a holder in consecutive different positions of application. FIG. 2A is a perspective view of a holder without sampling devices. FIG. 2B is a view of sampling devices assembled onto the holder. FIG. 2C is a holder with sampling devices activated by breaking tips. FIG. 2D is a perspective view of the holder where a flap is folded in safety position. FIG. 2E shows a process of clicking sampling tubes into sockets 25 and a locking cylinder 26. FIG. 2F shows devices after use and replacing safety caps on a sampling device.

FIG. 3 is an exploded perspective view of the main parts of the system shown on FIG. 1 and their interconnections.

FIG. 4 is a perspective view with a partial section view of the sampling head means of connecting and controlling the air flow with preset adjustable restricted orifices mounted in flow distributor on the pistol grip handle.

FIG. 5 shows one adjustable orifice mounted into each of the means for fast connection where FIG. 5A is a cross-sectional view of the adjustable orifice mounted in a socket-connector; FIG. 5B is a cross-sectional view of orifice forming adjustable air gap-orifice between the screw with wedged air channel and the body of the socket connector.

FIG. 6 is a schematic diagram of the pneumatic connection for the aerodynamic calibration of the means for moving air through sampling devices.

FIG. 7 is a schematic diagram of the sampling arrangement with sampling devices over the holder.

FIG. 8 represents a generic assembly of the system in which electric pump is replaced by optional pump Venturi pump assembly.

FIG. 9 represents a generic assembly of the system in which the electric pump is replaced by optional pump—hand driven piston pump. A hand pump adapter for pistol grip handle with air flow connector 101 is arranged between pump 100 and grip 40.

FIGS. 10A-10B represent moments of activation of the multitude sampling devices where: FIG. 10 A is showing a holder with sampling devices and the moment of opening the sampling devices by simultaneously breaking the tips of sampling tubes; FIG. 10 B is a perspective view of the means for activating sampling tube by crushing a build-in ampoule.

FIG. 11 is a perspective view of the generic assembly with extension rod and extension hose.

FIG. 12 is a perspective view of the assembly with extension cord and extension hose.

### DETAILED DESCRIPTION OF THE INVENTION

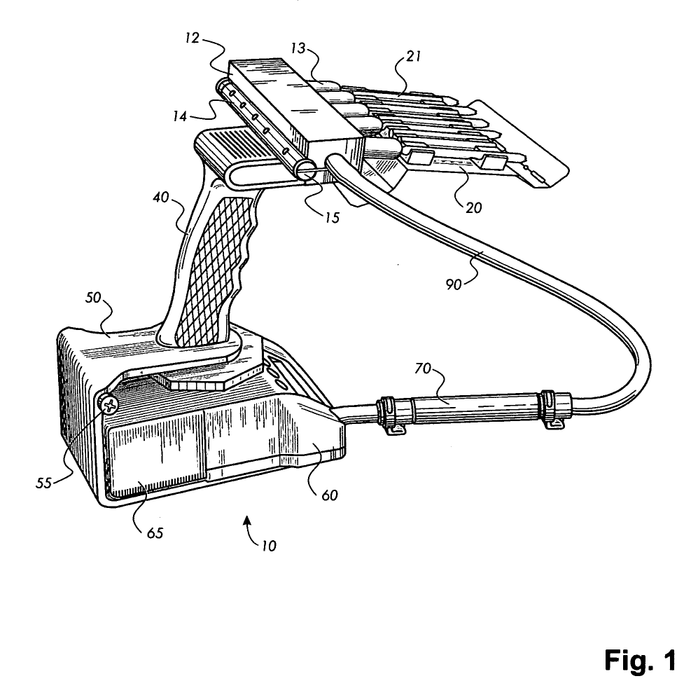

Referring now to the drawings in which like elements are designated by the same reference number throughout, there is shown in FIG. 1 a perspective view of the air sampling system 10 of the present invention. A pistol grip handle 40 provides a universal one-hand handle facilitation equipped with the capability of interchangeable components of vacuum pumps and extensions for collecting and sampling air from remote locations. On the top side of handle 40 is removably affixed sampling head 12. Sampling head 12 has a plurality of branches assembled on the front side with connecting sockets 18 and nipples 13 made preferably from flexible material such as rubber, soft plastic etc. The sockets 18 and nipples 13 face the sampling point and are connected to the sampling media through the sampling device 21. The number of the sockets 18 and nipples 13 can vary and is preferably more than two. Sampling devices 21 are directed forward towards an area from which an air sample is to be sampled. The grip 40 is held in a hand of an operator such that the operator can point the sampling holder 20 at any particular area or space. The sampling holder 20 carries colorimetric tubes, length-of-stain tubes, sorption tubes and/or other sampling devices on the intake side and includes a holding platform with preferably flat surface and preferably foldable front and back sides 20a and 20b. The front and back sides 20a and 20b protect the sampling device 21 during transit and storage.

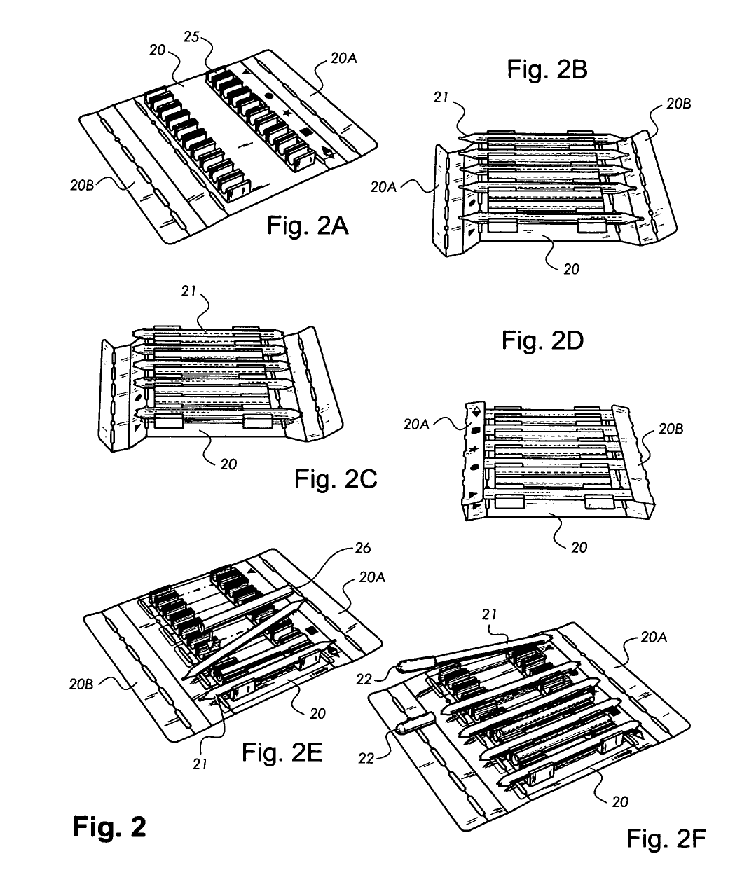

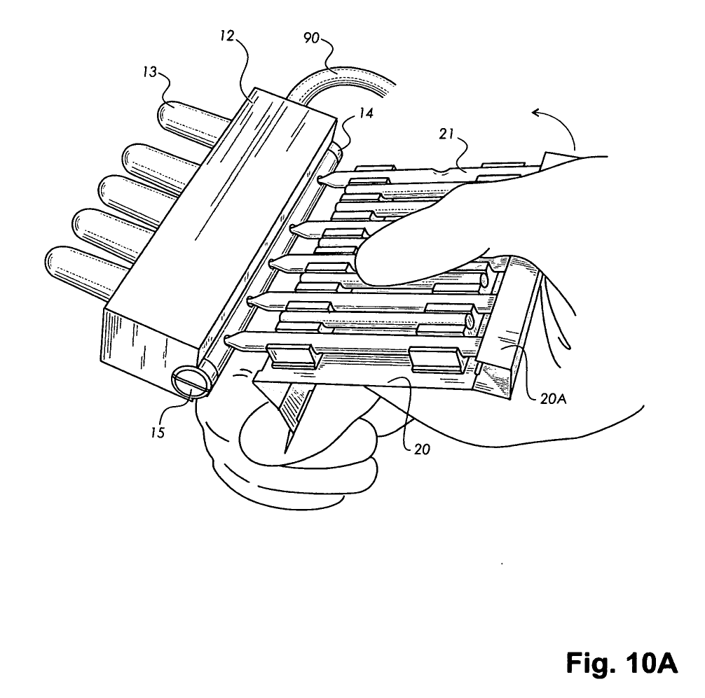

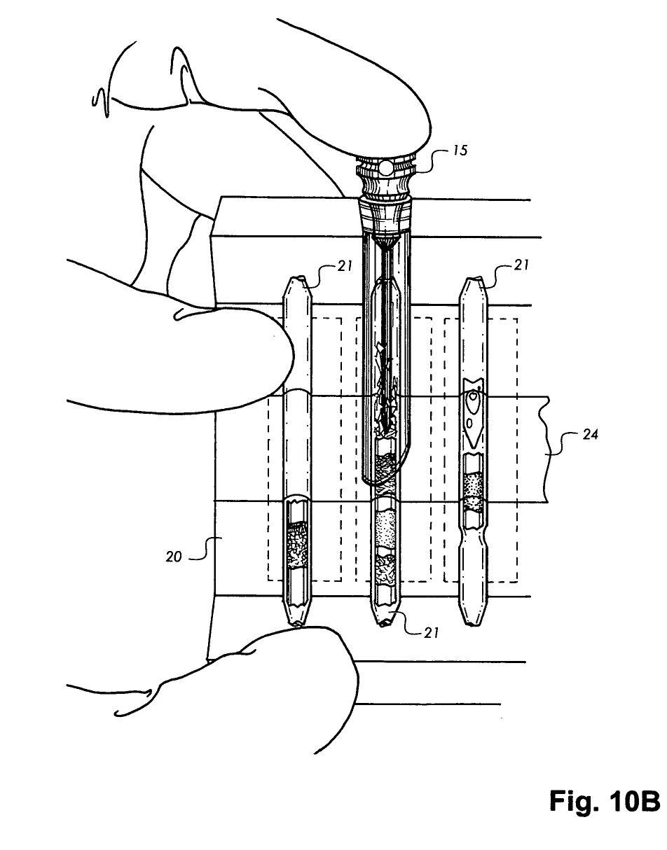

FIG. 2 shows a holder 20 for the air sampling devices 21 and one for the preferred methods of attachment by sockets 25; FIG. 2A. Sampling devices 21 which are including but not limited to colorimetric tubes, linear-colorimetric (length-of-stain) tubes, sorption sampling tubes, and filters or impinges are clicking into sockets 25 FIG. 2B. Holder 20 has on each side of the sampling devices tips two folding lines with apertures along the folding lines, thereby alleviating the folding. The area of holder 20 designated to be folded is marked as folding flaps 20A and 2B respectively. When folding the holder 20 along these folding lines allows folding flaps to form box looking structure—FIG. 2D. After performing operation to activate the devices 21 by breaking their sealed tips, operation shown separately on FIG. 10A, the results is devices with sharp edges shown on FIG. 2C and further shown covered by the box-looking structure—FIG. 2D. This formed structure prevents the hands of user from the sharp edges the broken glass. This feature is well seen also on FIG. 10A.

The sampling devices are locked in their places by locking cylinders 26 which increases friction on both sides of the devices and do not allow the devices to slide along the direction of force when devices has to be forcefully activated by breaking built-in ampoules—operation shown on FIG. 10B. The operation of locking the sampling devices into sockets is illustrated on FIG. 2E. After performing air sampling the devices their content and sharp edged broken tips are secured by safety caps 22 depicted on FIG. 2F.

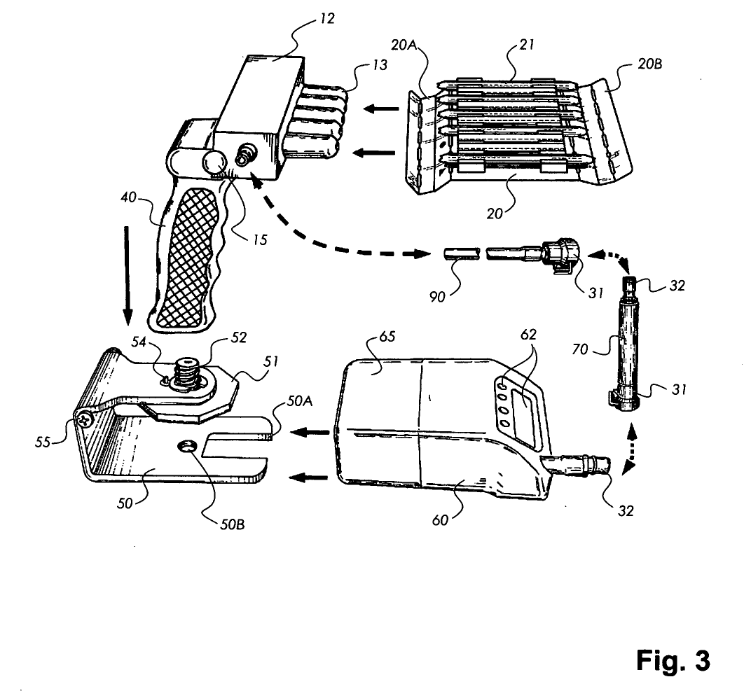

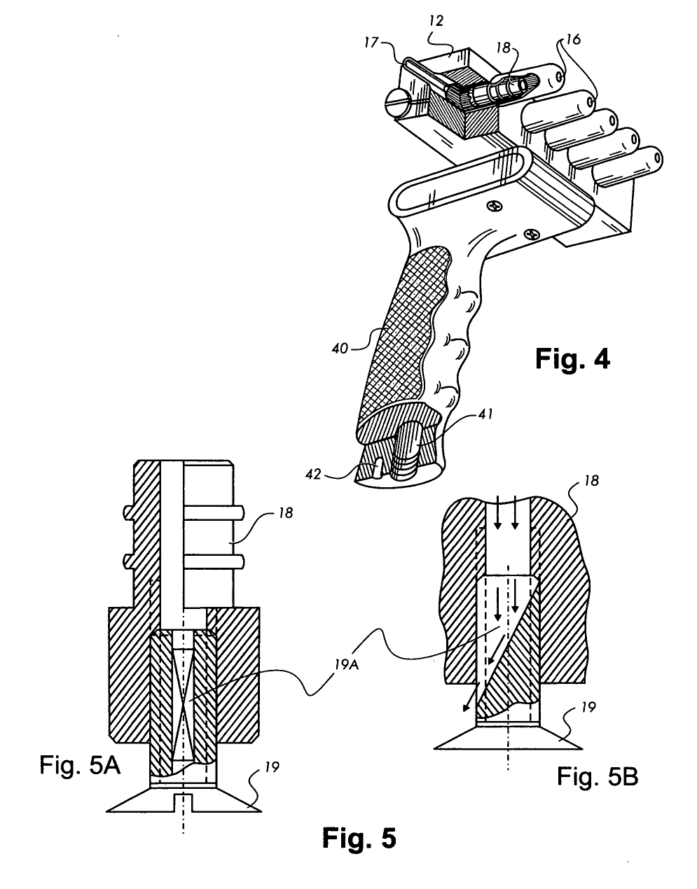

FIG. 3 is an exploded perspective view of the assembly 10 on FIG. 1 and shows an interconnection between the sampling pump 60 and the mounting bracket 50 by the threaded post 52 that rotates with a polygon 51. The threaded post 52 comprises threads which mate with recessed threads 41 shown in FIG. 4. Sampling head 12 is removably affixed on the top of handle 40 and has front portions with nipples 13 to receive and tighten the ends of the sampling devices 21 on the sampling assembly 20. The operating parameters such as airflow and sampling time are preset by the selecting means 62 on the front panel of the pump 60. Display screen 62 displays an operating menu as well as the operating parameters and may be a liquid crystal display or the like connected to a microprocessor. It is readily understood by those in the art that certain parameters such as an amount of air flow, temperature, barometric pressure, humidity, and other such environmental conditions may be measured by the microprocessor and respective sensor devices. Pump 60 has an integrated battery 65 which is a high capacity battery or rechargeable battery for multiple carrying out multiple sampling tasks. The pump 60 draws the total air flow through the filtering media 70, preferably a charcoal filter, connected by hose 90 to an inlet and inner vacuum collector 17 of sampling head 12. This inner vacuum collector 17 space connects to the socket connectors 18 better seen in FIG. 4. Thus, filter 70 serves to avoid internal contamination of pump 60 by the volatiles coming from the treated media of the reagent and/or reagents in the sampling devices and/or breakthrough of contaminants through the sampling devices 21.

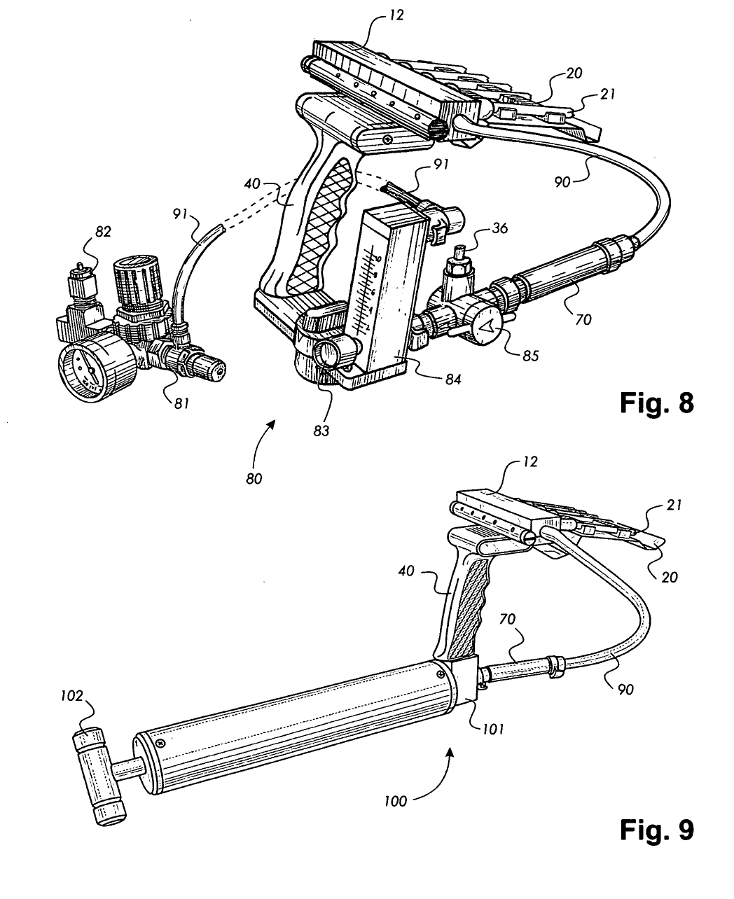

The sampling assembly 20 mates with nipples 13 on sampling head 12 mounted on the top of handle 40, which has a threaded inside surface 41, as shown in FIG. 4. The threaded inside surface 41 receives and mates with threads of the assembly post 52 in the center part of the mounting polygon washer 51 rotatably assembled onto the top part of the bracket 50. Preferably the threaded post 52 is mounted at the center of gravity of the bracket 50 and assembled pump 60 such that the system is balanced when held in the hand of the operator. Thus, the system is balanced with respect to its center of gravity such that it does not cause any undue strain on the hand or wrist of the operator during operation of the system. Pump 60 slides and locks into the bracket by the slot 50a and locking aperture 50b by the locking means on the bottom of the pump 60 (not shown in the figures). All pneumatic connections are achieved by quick locking connectors 31 male and 32 female, which allows fast interchanging of the parts of the air sampling system. One of these possible optional changes of the pumping device is to swap electric pump 60 with Venturi pump assembly 80 as shown in FIG. 8.

Venturi assembly 80 comprises Venturi pump 81 connected to a membrane pressure regulator and through t-connector 82 with relief valve to high pressure air supply. Venturi pump 81 uses high pressurized air from an air cylinder or other source to create a vacuum flow which in turn drives an air sample by hose 91 through flow meter 84. Flow meter 84 includes a regulator valve 83 and is connected by fast connector 32 to the filter 70. The regulator valve may be adjusted to control the air flowing into the sampling assembly 20. This embodiment represents an intrinsically safe variant for collecting air samples in environments containing explosive gases.

FIG. 4 shows two partially cutaway views of the pistol grip handle 40 having assembly thread 41 and locking aperture 42 helping to position the handle forward. Aperture 42 receives post 54, same as in FIG. 3, such that the handle 40 is always positioned in a forward direction with respect to the mounting bracket 50 thereby assuring that the system is balanced. The partial cutaway view of the sampling head 12 shows the adjustable resistance assembly comprising an internally threaded orifice into socket connector 18 and screw 19 having a narrow sloped longitudinal channel 19A as shown in FIG. 5a and FIG. 5b. By adjusting the screw length of 19 into orifice 18, the cross-section of the airflow through the air channel changes causing a change in the aerodynamic resistance. This allows particular airflows of each branch to be adjusted according to the requirements of the sampling devices 21 as shown on schematic diagram FIG. 7, representing sampling device attached on the holder.

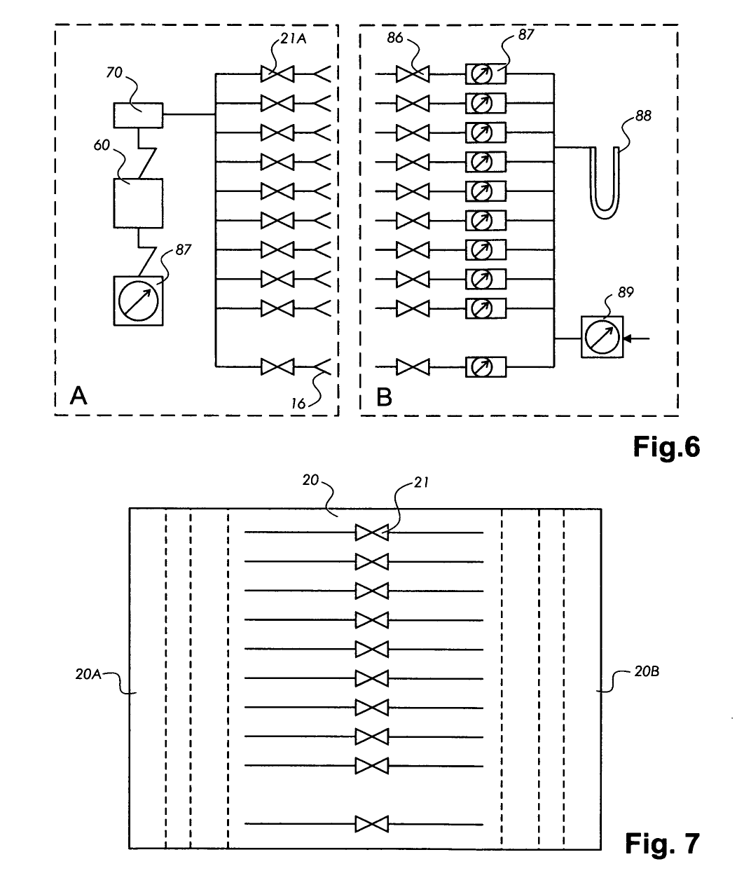

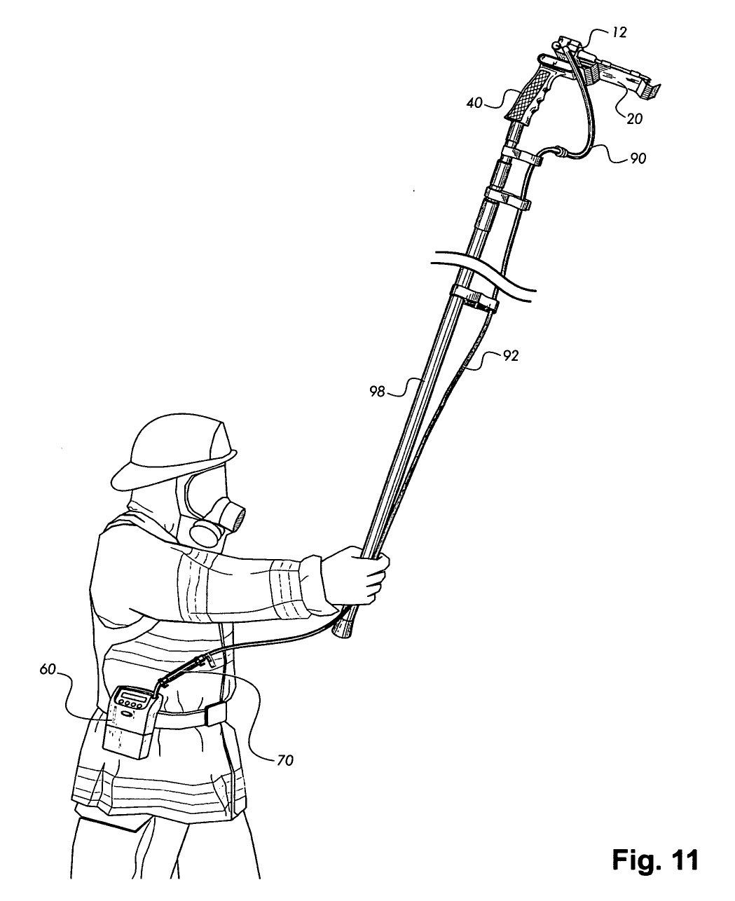

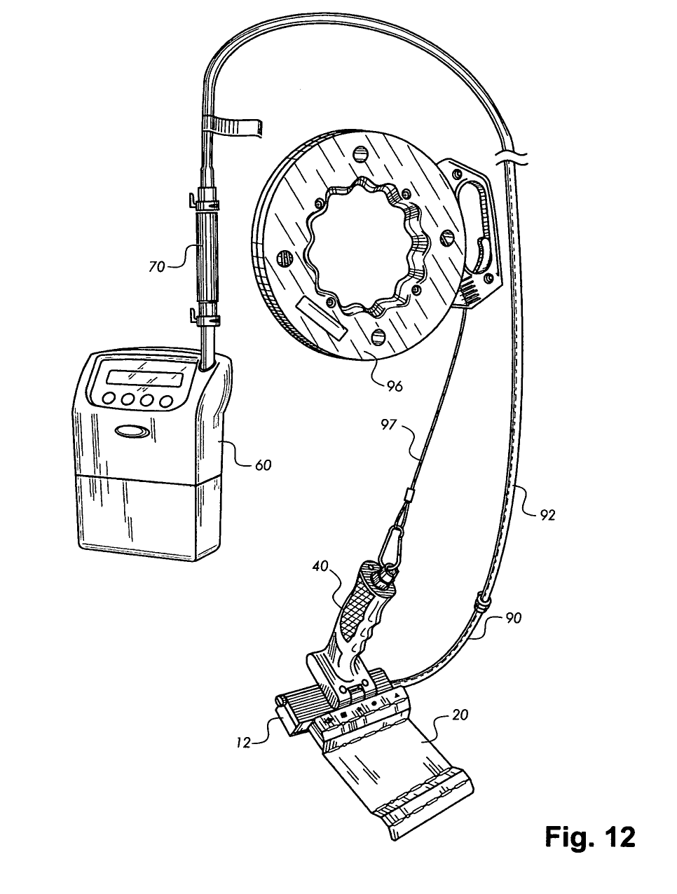

FIG. 6 represents a schematic diagram of the main parts of the air sampling system, and the air sampling system A holder with sampling device connectable to the calibration system B. Calibration system B comprises multitudes of adjustable resistances 86 each one connected through flow meters 81 to the connector-splitter 82 with a differential manometer 88 and flow meter 89 which measures the total inlet flow. The pump 60 or 80 drives the air through the filter 70 and adjustable resistance assembly 18 and 19 connected by the nipples 13 to the adjustable resistances 86. Resistances 86 are pre-adjusted to represent the resistance of the air flow at the same sampling condition drawn through the real array of samplers 21 mounted on the holder. Once adjusted, system B is exchanged for a real sampler array 20 that includes several sampling devices 21. Devices 21 (a, b, c, d and f) are detector tubes, colorimetric or length of stain sampling tubes, filters, Impingers etc. depending upon the intended purpose of the complex analysis to be carried out. Typically, the air flow for each branch is separately adjustable from 0.5 to 5 LPM by the adjustable resistance assembly 18 and 19. The total airflow is pre-adjustable from 0.5 to 20 LPM. From 2 to 12 branches preferably 3 to 5 could be used simultaneously but there is no limitations of the number of branches given the pump can always supply the sampling vacuum needed to carry out an analysis. The air sampling system A has a possibility to sample at remote high points by the use of extension rod 98 as shown in FIG. 11 with assembly screw 52 at the end and extension hose 92. Another option is to use the air sampling system in manholes, for example one that may be lowered into a hole. Using cord 97 the assembly is lowered into an opening of a manhole. The advantage of this remote sampling capability is that the sampling head 12 and sampling array 20 are directly exposed to the sampled air without the need for a long hose which may absorb considerable amount of analytes.

Pistol grip handle 40 can be easily adapted with adapter 101 to hand pump 100 as shown in FIG. 9. Handle 102 is pulled outwards from hand pump 100 to create a vacuum causing air to flow into the assembly 20. Sampling assembly 20, shown in FIG. 2, comprises a holding platform with preferably flat surface and preferably foldable front and back sides 20a and 20b. These sides (lips) allow the assembly 20 to form a box for shipping and storage and are used as hand-safety guards, when the sampling devices ends (tips) have been broken for use. The preferable method of breaking the ends or tips of the sampling devices includes inserting the tips into the holes of the tube breaker 14 as seen in FIG. 10A. The assembly 20 is then forced in an upward or downward direction causing the tips to be broken from the samplers 21. After the tips of sampling devices are broken with tube's breaker, some of the sampling devices may need activation by crushing the built-in tube ampoules with reagent using awl 15; operation depicted in FIG. 10B. The whole assembly 20 is secured into the nipples 13 on the front side of sampling head-12. Sampling head 12 includes an air channel 17 connected to all branches with sockets 13 by adjustable aerodynamic resistances assembly 18 and 19 better seen in FIG. 4, FIG. 5A and FIG. 5B. The bottom part of the pistol grip handle 40 is connected to the pump bracket 50 carrying an electric air sampling pump 60. The electric pump 60 has built-in software and means 62 to be adjusted and programmed to draw the airflow through air filter 70 trapping all the inorganic and organic volatiles passing through the hose 90 from the sampling head 12. Filter 70 is preferably a low resistant absorbing media filter designed to allow only clean air to pass through any pump unit in use and therefore not to contaminate the insides of the sampling equipment.

1. A one-hand operated, ergonomic, gravity balanced upright self standing system for simultaneous qualitative and quantitative air sampling of at least an individual analyte, said system comprising:
at least one individual sampling device that performs an analysis of an air sample to determine the presence of an analyte in the air sample;
a removably affixing holder for holding the at least one individual sampling device;
an upright holding means connected to said removably affixing holder;
a plurality of preset adjustable restriction orifices, one of said preset adjustable restriction orifices controlling a preset air flow through the at least one individual sampling device and connected thereto;
an in-line decontamination filtration connected in series to said at least one individual sampling device;
means for moving air through said at least one individual sampling device in series with the preset adjustable restriction orifices and engageable with said upright holding means;
a nipple that quickly couples the at least one individual sampling device to said means for moving air through said at least one individual sampling device; and,
means for controlling and recording preset predefined air volume and air flow rate drawn through said system.

2. The system according to claim 1 wherein said removably affixing holder further comprises:
a snap-in mechanism comprising sockets for holding the at least one individual sampling device on said removably affixing holder: and
a means for protecting a user's hands from sharp edges of an opened individual sampling device and connected to said removably affixing holder.

3. The system according to claim 1 further comprises:
means for opening said at least one individual sampling device; and,
means for crushing ampoules.

4. The system according to claim 1 wherein said means of holding said system in an upright position further comprises:
a threaded bayonet fitting that engages said means for moving air through said at least one individual sampling device; and,
a pistol grip handle.

5. The system according to claim 1 wherein said
said removable affixing holder comprises a socket for holding the at least one individual sampling device.

6. The system according to claim 1 wherein said means for moving air through said at least one individual sampling device comprises:
a pump selected from a group consisting of an electric pump, Venturi pump assembly or hand piston pump; and,
a complementary pair of quick locking connectors that quickly connect and disconnect a suction flow to the plurality of preset adjustable restriction orifices through the at least one individual sampling device.

7. The system according to claim 6 wherein said electric pump further comprises:
an adjustable airflow;
an adjustable input for varying a sampling parameter;
exit port inside the pump housing for creating a positive pressure to prevent contaminants from entering the pump;
a shielded exhaust to prevent water from entering the pump;
means for charging a power source connected to the pump and selected from a group consisting of alternating current, direct current, solar and manual cranking energy supplies;
means for estimating percentage of life service and remaining run time of said power source;
a digital imaging system to take pictures of sampling devices after sampling and comparing a result to stored data;
preset sampling parameters including air flow, air volume, back pressure, run time;
preset programmable one button operation;
a digital display;
a failure indicator for air flow rate, air volume and run time;
means for measuring and recording ambient temperature, humidity and pressure and automatically compensating adjusted or preset sampling parameters;
means for communicating programmable sampling parameters from a remote location to said system; and,
means for recording a part number, lot numbers, expiration dates, and serial numbers of said individual sampling device or plurality of sampling devices and automatically notify user and manufacturer.

8. The system according to claim 1 further comprising:
a threaded bayonet fitting that holds said system in an upright position; and,
an L-shaped member having a first and second end, wherein one or both the first and second ends include threaded fittings.

9. The system according to claim 1 further comprising:
a flat bar having different shaped orifices, each orifice having a dial-in design.

10. The system according to claim 1 wherein said individual analyte or plurality of analytes include but not limited to warfare agents and indoor air pollutants.

11. The system according to claim 1 wherein said at least one individual sampling device further comprises:
an individual sampling device selected from a group consisting of direct read, length of stain quantitative and semi quantitative colorimetric detector tubes, sorption tubes, filters housing, and impingers;
printed part numbers and lot numbers for visual and digital recognition; and,
after-use caps for proper disposal
wherein an inside diameter of the individual sampling device ranges between 2.0 mm to 4.8 mm.

12. The system according to claim 1 wherein said at least one individual sampling device further comprises:
a plurality of two to five sampling devices.

13. The system according to claim 7 wherein said adjustable sampling parameters include air flow, air volume, back pressure, run time and consists of:
flow rates in the range of 0.5 L/min to 5.0 L/min for a second sampling device, flow rates in the range of 0.75 L/min to 7.50 L/min for a third sampling device, flow rates in the range of 1.0 L/min to 10.0 L/min for a fourth sampling device, flow rates in the range of 1.2 L/min to 12.0 L/min for a fifth sampling device;
air volumes in the range of 1.5 L to 15 L for a sampling device, air volumes in the range of 2 to 25 L for a sampling device, air volumes in the range of 2.5 L to 40 L for a sampling device, air volumes in the range of 3 L to 30 L for a sampling device;
back pressures in the range of 60″ water to 20″ water for a sampling device, back pressures in the range of 55″ water to 15″ water for a sampling device, back pressures in the range of 50″ water to 10″ water for a sampling device, back pressures in the range of 48″ water to 7″ water for a sampling device;
run times in the range of 1 minute to 5 minutes for a sampling device, run times in the range of 1 minute to 5 minutes for a sampling device, run times in the range of 2 minutes to 7 minutes for a sampling device, run times in the range of 2.5 minutes to 10 minutes for a sampling device.

14. The system according to claim 13 wherein back pressure further comprises the same value for all sampling devices.

15. The system according to claim 1 wherein each of the plurality of adjustable orifices further comprises:
an individual unique shape and size to avoid wrong placement of the at least one individual sampling device in the proper position.

16. The system according to claim 1 wherein said in-line decontamination filtration further comprises:
an end of service life indicator; and,
after use caps for proper disposal.

17. A chemical monitoring and detection system comprising:
a holder for holding a removable sacrificial sampling device;
at least one removable sacrificial sampling device that analyses an air sample and indicates the presence of an analyte;
a pump connected to the removable sacrificial sampling device and for drawing an airflow there through;
a filter connected between said sampling device and the pump and for preventing the pump from becoming internally contaminated; and,
an adjustable restricting orifice for adjusting an amount of air flowing through said at least one removable sacrificial sampling device.

18. The chemical monitoring and detection system of claim 17 further wherein said filter prevents internal contamination of the pump from chemical warfare agents.

19. The chemical monitoring and detection system of claim 17 wherein the at least one removable sacrificial sampling device includes a plurality of sacrificial sampling devices having one or more unique operating characteristic selected from a list of variables consisting of back pressure, air volumes, run times and air flow rates.

20. The chemical monitoring and detection system of claim 17 further comprising:
a housing for holding said pump; and,
a pistol grip handle connected between said housing and the holder.
